(19) United States
(12) Patent Application Publication
(10) Pub. No.: US 2026/0010203 A1
(43) Pub. Date: Jan. 8, 2026

(54) DISPLAY DEVICE, METHOD OF FABRICATING THE SAME, AND ELECTRONIC DEVICE INCLUDING THE SAME

(71) Applicant: SAMSUNG DISPLAY CO., LTD., YONGIN-SI (KR)

(72) Inventors: Sung Sang AHN, Yongin-si (KR); Min Sung KIM, Yongin-si (KR)

(21) Appl. No.: 19/172,862

(22) Filed: Apr. 8, 2025

(30) Foreign Application Priority Data
Jul. 3, 2024 (KR) 10-2024-0087429

(51) Int. Cl. G06F 1/16

(52) U.S. Cl. CPC G06F 1/1641

(57) ABSTRACT

A display device includes a display panel comprising a folding area, and a panel support member disposed on a surface of the display panel. The panel support member includes a folding portion overlapping the folding area, and multiple bars spaced apart from each other in the folding portion.

This application claims priority from Korean Patent Application No. 10-2024-0087429 filed on Jul. 3, 2024, in the Korean Intellectual Property Office, and all the benefits accruing therefrom under 35 U.S.C. 119, the contents of which in its entirety are herein incorporated by reference.

### BACKGROUND

### 1. Field of the Disclosure

The present disclosure relates to a display device and a method of fabricating the same.

### 2. Description of the Related Art

As the information-driven society continues to progress, the demand for display devices is rapidly growing. These devices are now integral to a wide range of electronic products, including smartphones, digital cameras, laptops, navigation systems, and smart TVs.

Recently, to enhance the portability of display devices and offer larger screen areas, bendable display devices that can be flexed and foldable display devices that can be folded have been introduced to the market.

### SUMMARY

Aspects of the present disclosure provide a display device in which a distance between spaces formed in a folding portion of a panel support member can be reduced, and a method of fabricating the same.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, a display device includes a display panel includes a folding area, and a panel support member disposed on a surface of the display panel, wherein the panel support member includes, a folding portion overlapping the folding area, and multiple bars spaced apart from each other in the folding portion.

Each bar of the multiple bars extends lengthwise in a first direction and the multiple bars are spaced apart from each other in a second direction perpendicular to the first direction, and the panel support member extends lengthwise in the second direction.

The panel support member has longer sides extending in the second direction, and shorter sides extending in the first direction, and a length of the multiple bars in the first direction is equal to a length of the shorter sides of the panel support member.

The panel support member further includes a first non-folding portion, and a second non-folding portion spaced apart from the first non-folding portion. The folding portion is located between the first non-folding portion and the second non-folding portion. A first space is formed between the first non-folding portion and a first outermost bar of the multiple bars, multiple second spaces are formed between two adjacent multiple bars of the multiple bars, and a third space is formed between the second non-folding portion and a second outermost bar of the multiple bars.

A length of the first space in the first direction is equal to a length of the multiple bars in the first direction.

The first space, the third space, and each of the multiple second spaces have the same width in the second direction and the same length in the first direction.

A width of the first space in the second direction is less than a half of a thickness of the first outermost bar in a third direction perpendicular to the first and second directions.

The display device further includes a lower protection member disposed between the display panel and the panel support member. The lower protection member is attached to the panel support member and is configured to maintain the first space, the multiple second spaces, and the third space.

The lower protection member has a recessed surface at a lower surface, the lower surface except for the recessed surface contacts the panel support member, and the recessed surface is spaced apart from a region where the multiple bars are disposed.

According to an aspect of the present disclosure, a method of fabricating a display device includes preparing a panel support member comprising a folding portion and multiple bars spaced apart from each other in the folding portion to form spaces, connecting at least one distance adjuster to the panel support member, moving the at least one distance adjuster to reduce the spaces of the panel support member, stacking a lower protection member on a surface of the panel support member, and removing the at least one distance adjuster from the panel support member.

The panel support member further includes a first non-folding portion, and a second non-folding portion spaced apart from the first non-folding portion. The folding portion is located between the first non-folding portion and the second non-folding portion. The connecting of the at least one distance adjuster to the panel support member includes connecting the at least one distance adjuster to the first non-folding portion, the second non-folding portion, and each of the multiple bars.

The at least one distance adjuster includes a moving member, connecting wires and bridges. The connecting of the at least one distance adjuster to the panel support member includes connecting first ends of the connecting wires to the first non-folding portion, the second non-folding portion and the multiple bars, connecting second ends, opposite to the first ends, of the connecting wires to the moving member, and connecting the first non-folding portion and the second non-folding portion with the moving member through the bridges.

The at least one distance adjuster includes a plurality of distance adjusters, and the plurality of distance adjusters includes a first distance adjuster and a second distance adjuster. The first distance adjuster and the second distance adjuster are connected to the panel support member on opposite sides of the panel support member in a first direction perpendicular to a second direction in which the panel support member extends lengthwise.

The connecting of the connecting wires to the first non-folding portion, the second non-folding portion and the multiple bars includes connecting first ends of first connecting wires and first ends of second connecting wires to the first non-folding portion, the second non-folding portion and the multiple bars on the opposite sides of the panel support member in the first direction perpendicular to the second direction in which the panel support member extends lengthwise. The connecting of the connecting wires to the moving member further includes connecting second ends, opposite to the first ends, of the first connecting wires to a first moving member, and second ends, opposite to the first ends, of the second connecting wires to a second moving member. The connecting of the first non-folding portion and the second non-folding portion with the moving member through the bridges includes connecting the first non-folding portion and the second non-folding portion with the first moving member by a first bridge, and connecting the first non-folding portion and the second non-folding portion with the second moving member by a second bridge.

The method of fabricating a display device further includes placing the panel support member with the at least one distance adjuster connected thereto on a stacking jig, and removing, after the placing of the panel support member on the stacking jig, the bridges from the panel support member.

The multiple bars are spaced apart from each other in the second direction and each bar of the multiple bars extends lengthwise in the first direction. The moving of the at least one distance adjuster includes arranging the first moving member and the second moving member in the first direction in which the multiple bars extend lengthwise so that the first moving member and the second moving member are adjacent to opposite longer sides of the panel support member.

The moving of the at least one distance adjuster further includes moving the first moving member and the second moving member in opposite directions parallel to the first direction.

The moving of the first moving member and the second moving member in the opposite direction includes pulling the first non-folding portion, the second non-folding portion, and the multiple bars in the opposite directions to cause the first non-folding portion, the second non-folding portion and the multiple bars to move in the second direction in which the panel support member extends lengthwise.

The moving of the at least one distance adjuster further includes moving the first moving member so that at least one of the first connecting wires is arranged in parallel to the first direction in which the multiple bars extend lengthwise, and moving the second moving member so that at least one of the second connecting wires is arranged in parallel to the first direction.

A width of the reduced spaces in a direction in which the panel support member extends lengthwise is equal to or less than 50 μm.

According to an embodiment of the present disclosure, spaces formed in a folding portion of a panel support member in a display device can be reduced by connecting a distance adjuster to the panel support member to move the distance adjuster.

According to an aspect of the present disclosure, an electronic device includes a display device, and a power supply configured to provide power to the display device. The display device includes a display panel comprising a folding area, and a panel support member disposed on a surface of the display panel. The panel support member includes a folding portion overlapping the folding area, and multiple bars spaced apart from each other in the folding portion.

The effects according to the embodiments of the present disclosure are not limited to those mentioned above and more various effects are included in the following description of the present disclosure.

### BRIEF DESCRIPTION OF THE DRAWINGS

The above and other aspects and features of the present disclosure will become more apparent by describing in detail example embodiments thereof with reference to the attached drawings, in which:

FIG. 1 is a perspective view showing a display device according to an embodiment of the present disclosure when it is unfolded.

FIG. 2 is a perspective view showing the display device of FIG. 1 when it is folded.

FIG. 3 is a perspective view showing a display device according to another embodiment of the present disclosure when it is unfolded.

FIG. 4 is a perspective view showing the display device of FIG. 3 when it is folded.

FIG. 5 is a cross-sectional view showing a display device according to an embodiment of the present disclosure.

FIG. 6 is a schematic cross-sectional view of the display panel of FIG. 5.

FIG. 7 is a plan view showing a panel support member of a display device according to an embodiment of the present disclosure with a distance adjuster connected thereto.

FIG. 8 is an enlarged view of portion A of FIG. 7.

FIG. 9 is a view showing a modification of the embodiment shown in FIG. 8.

FIG. 10 is a plan view showing the panel support member of FIG. 7 after the bridges of the distance adjuster have been removed.

FIG. 11 is an enlarged view of portion B of FIG. 10.

FIG. 12 is a plan view showing the panel support member of FIG. 10 when the moving member of the distance adjuster is moved.

FIG. 13 is an enlarged view of portion C of FIG. 12.

FIG. 14 is a plan view showing the panel support member of FIG. 12 when a lower protection member is stacked on it.

FIG. 15 is a plan view showing the panel support member of FIG. 14 after the distance adjuster has been removed.

FIG. 16 is a block diagram illustrating an electronic device according to an embodiment.

### DETAILED DESCRIPTION OF THE EMBODIMENTS

Advantages and features of the present disclosure and methods to achieve them will become apparent from the descriptions of example embodiments hereinbelow with reference to the accompanying drawings. However, the present disclosure is not limited to example embodiments disclosed herein but may be implemented in various different ways. The example embodiments are provided for making the disclosure of the present disclosure thorough and for fully conveying the scope of the present disclosure to those skilled in the art. It is to be noted that the scope of the present disclosure is defined only by the claims.

As used herein, a phrase “an element A on an element B” refers to that the element A may be disposed directly on the element B and/or the element A may be disposed indirectly on the element B via another element C. Like reference numerals denote like elements throughout the descriptions. The figures, dimensions, ratios, angles, numbers of elements given in the drawings are merely illustrative and are not limiting.

Although terms such as first, second, etc. are used to distinguish arbitrarily between the elements such terms describe, and thus these terms are not necessarily intended to indicate temporal or other prioritization of such elements. These terms are used to merely distinguish one element from another. Accordingly, as used herein, a first element may be a second element within the technical scope of the present disclosure.

Features of various example embodiments of the present disclosure may be combined partially or totally. As will be clearly appreciated by those skilled in the art, technically various interactions and operations are possible. Various example embodiments can be practiced individually or in combination.

Hereinafter, example embodiments of the present disclosure will be described in detail with reference to the accompanying drawings.

The present inventive concept relates to a method of reducing spaces between multiple bars and spaces between the multiple bars and non-folding portions of a support member using a moving member which is pulled in opposite directions parallel to a direction in which the multiple bars extend lengthwise. Using this method may enable a width of the spaces to be less than a half of a thickness of the multiple bars.

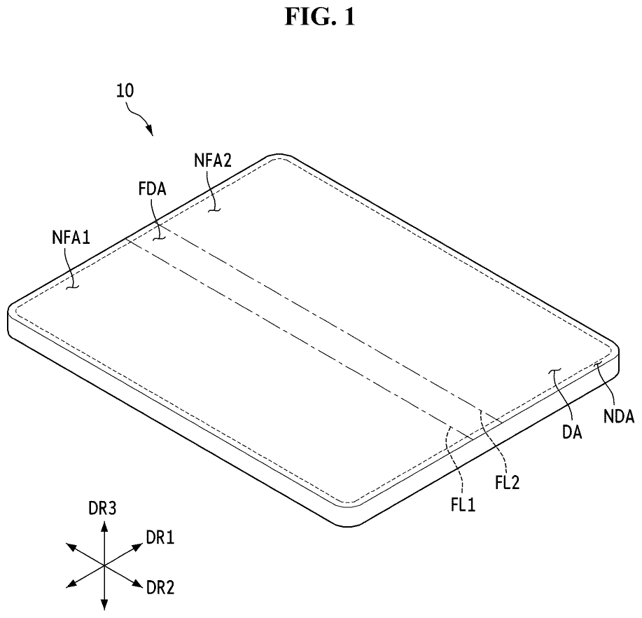

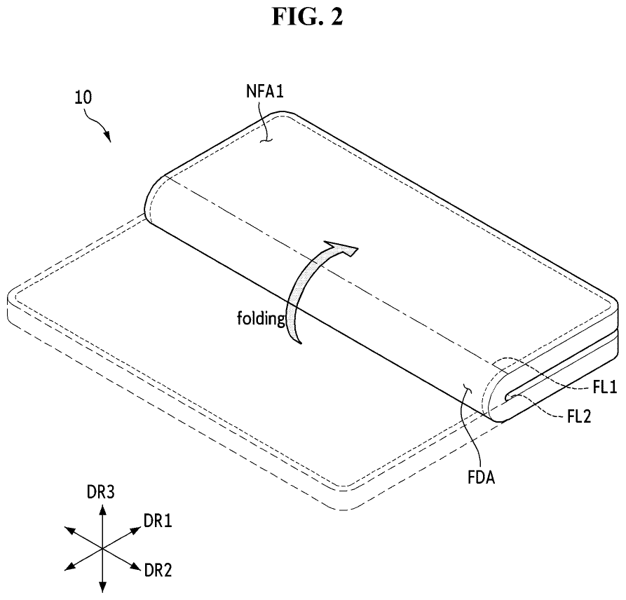

FIG. 1 is a perspective view showing a display device according to an embodiment of the present disclosure when it is unfolded. FIG. 2 is a perspective view showing the display device of FIG. 1 when it is folded.

Referring to FIGS. 1 and 2, FIG. 1 shows a first state in which the display device 10 is unfolded without being folded over the folding lines FL1 and FL2, and FIG. 2 shows a second state in which the display device 10 is folded over the folding lines FL1 and FL2.

A display device 10 according to the example embodiment of the present disclosure is for displaying moving images or still images. The display device 1 may be used as the display screen of portable electronic devices such as a mobile phone, a smart phone, a tablet PC, a smart watch, a watch phone, a mobile communications terminal, an electronic notebook, an electronic book, a portable multimedia player (PMP), a navigation device and an ultra-mobile PC (UMPC), as well as the display screen of various products such as a television, a notebook, a monitor, a billboard and the Internet of Things.

As shown in FIGS. 1 and 2, a first direction DR1 may refer to a direction parallel to a side of the display device 10, for example, the horizontal direction of the display device 10 when viewed from the top. A second direction DR2 may refer to a direction parallel to another side of the display device 10 that meet the side of the display device 10, for example, the vertical direction of the display device 10 when viewed from the top. A third direction DR3 may refer to a thickness direction of the display device 10.

The display device 10 may have a quadrangular shape, such as a rectangular shape when viewed from the top. Each of the corners of the display device 10 may form a right angle or may be rounded when viewed from the top. The front surface of the display device 10 may include two shorter sides extended in the first direction DR1 and two longer sides extended in the second direction DR2.

The display device 10 may include the display area DA and a non-display area NDA. The shape of the display area DA may follow or may be similar to the shape of the display device 10 when viewed from the top. For example, when the display device 10 has a rectangular shape when viewed from the top, the display area DA may also have a rectangular shape when viewed from the top.

The display area DA may include a plurality of pixels to display images. The non-display area NDA may not include pixels and thus may not display images. The non-display area NDA may be disposed around the display area DA. The non-display area NDA may surround the display area DA, but the example embodiments of the present disclosure are not limited thereto. The display area DA may be partially surrounded by the non-display area NDA.

The display device 10 may stay either in a first state when it is unfolded or a second state when it is bent. The display device 10 may be folded inward so that a part of the display device DA faces the other part (in-folding manner), as shown in FIG. 2. In this instance, a part of the front surface of the display device 10 may face the other part when it is folded. Alternatively, the display device 10 may be folded outward (out-folding manner) such that a part of the rear surface faces the other part when it is folded.

The display device 10 may include a folding area FDA, a first non-folding area NFA1, and a second non-folding area NFA2. The display device 10 can be bent or folded at the folding area FDA, while it cannot be bent or folded at the first non-folding area NFA1 and the second non-folding area NFA2. According to an embodiment of the present disclosure, the first non-folding area NFA1 and the second non-folding area NFA2 may be flat areas of the display device 10. The first non-folding area NFA1 may be disposed on one side, for example, the left side of the folding area FDA. The second non-folding area NFA2 may be disposed on the opposite side, for example, the right side of the folding area FDA. The folding area FDA may be defined by the first folding line FL1 and the second folding line FL2, where the display device 10 can be bent with a predetermined curvature. The first folding line FL1 may be the boundary between the folding area FDA and the first non-folding area NFA1, and the second folding line FL2 may be the boundary between the folding area FDA and the second non-folding area NFA2.

The first folding line FL1 and the second folding line FL2 may be extended in the second direction DR2 as shown in FIGS. 1 and 2, and the display device 10 may be folded along the second direction DR2. Accordingly, the length of the display device 10 in the first direction DR1 can be reduced to about half, so that the display device 10 is easy to carry.

When the first folding line FL1 and the second folding line FL2 are extended in the second direction DR2 as shown in FIGS. 1 and 2, the length of the folding area FDA in the second direction DR2 may be larger than the length in the first direction DR1. The length of the first non-folding area NFA1 in the second direction DR2 may be larger than the length of the first non-folding area NFA1 in the first direction DR1. The length of the second non-folding area NFA2 in the second direction DR2 may be larger than the length of the second non-folding area NFA2 in the first direction DR1.

Each of the display area DA and the non-display area NDA may overlap at least one of the folding area FDA, the first non-folding area NFA1, and the second non-folding area NFA2. In the example shown in FIGS. 1 and 2, each of the display area DA and the non-display area NDA overlaps the folding area FDA, the first non-folding area NFA1 and the second non-folding area NFA2.

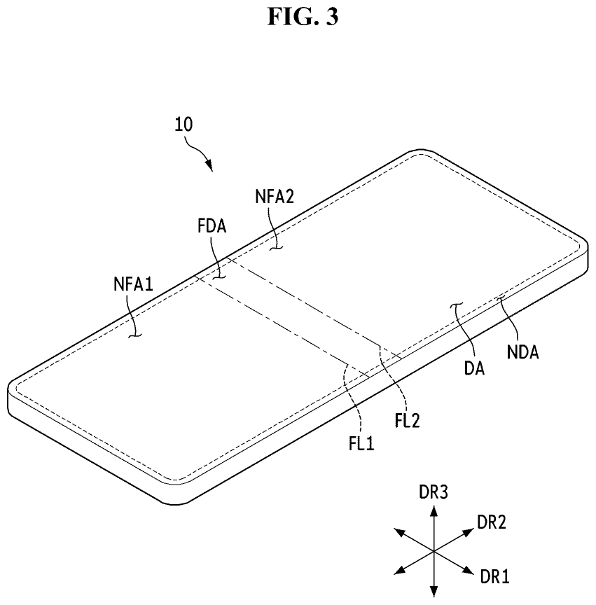

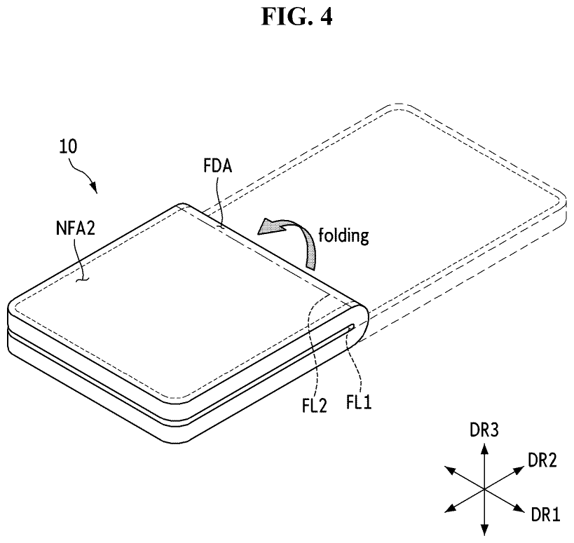

FIG. 3 is a perspective view showing a display device according to another embodiment of the present disclosure when it is unfolded. FIG. 4 is a perspective view showing the display device of FIG. 3 when it is folded.

The example embodiment of FIGS. 3 and 4 is substantially identical to the example embodiment of FIGS. 1 and 2 except that a first folding line FL1 and a second folding line FL2 are extended in the first direction DR1 and a display device 10 can be folded in the second direction DR2, so that the length of the display device 10 in the second direction DR2 can be reduced by approximately half. Therefore, the elements of FIGS. 3 and 4 identical to those of FIGS. 1 and 2 will not be described to avoid redundancy.

Referring to FIGS. 3 and 4, FIG. 3 shows a first state in which the display device 10 is unfolded without being folded over the folding lines FL1 and FL2, and FIG. 4 shows a second state in which the display device 10 is folded over the folding lines FL1 and FL2.

In the first state in which the display device 10 is unfolded, the longer sides of the display device 10 may be extended in the second direction DR2, and the shorter sides of the display device 10 may be extended in the first direction DR1.

The first folding line FL1 and the second folding line FL2 may be extended in the first direction DR1 as shown in FIGS. 3 and 4, and the display device 10 may be folded in the second direction DR2.

The first non-folding area NFA1 may be disposed on one side, for example, the lower side of the folding area FDA. The second non-folding area NFA2 may be disposed on the opposite side, for example, the upper side of the folding area FDA.

When the first folding line FL1 and the second folding line FL2 are extended in the first direction DR1 as shown in FIGS. 3 and 4, the length of the folding area FDA in the first direction DR1 may be larger than the length in the second direction DR2. The length of the first non-folding area NFA1 in the second direction DR2 may be larger than the length of the first non-folding area NFA1 in the first direction DR1. The length of the second non-folding area NFA2 in the second direction DR2 may be larger than the length of the second non-folding area NFA2 in the first direction DR1.

In the following description, the embodiment of FIGS. 3 and 4 will be described as an example for convenience of illustration, but the present disclosure is not limited thereto. The following description may be equally applied to the embodiment of FIGS. 1 and 2.

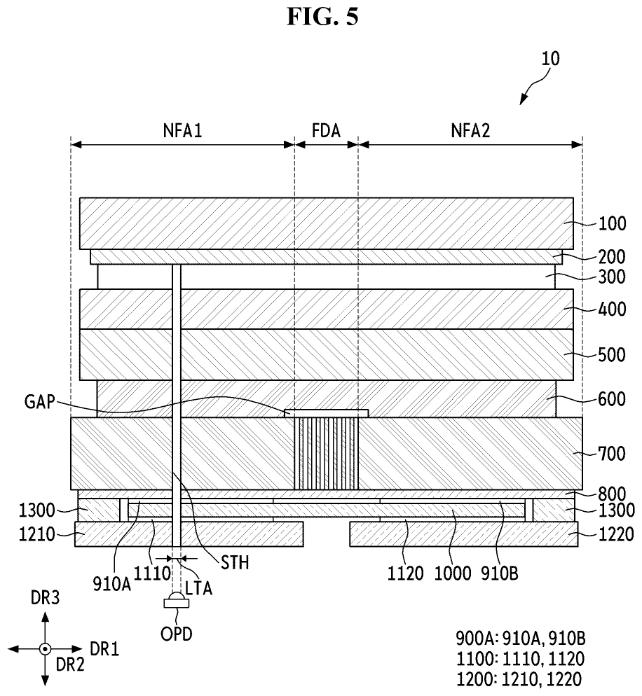

FIG. 5 is a cross-sectional view showing a display device according to an embodiment of the present disclosure.

Referring to FIG. 5, the display device 10 according to an embodiment may include a first upper protection member 100, a window member 200, a first adhesive member 300, a second upper protection member 400, a display panel 500, a lower protection member 600, a panel support member 700, a buffer member 800, a second adhesive member 900A, a lower functional member 1000, a third adhesive member 1100, a metal support member 1200, and an anti-permeation member 1250.

The display panel 500 may be a panel for displaying images. The display panel 500 may be an organic light-emitting display panel including an organic light-emitting layer as the light-emitting elements, a quantum-dot light-emitting display panel including a quantum-dot light-emitting layer as the light-emitting elements, an inorganic light-emitting display panel using inorganic semiconductor elements as the light-emitting elements, or a micro light-emitting display panel using micro light-emitting diodes as the light-emitting elements. In the following description, an organic light-emitting display panel is employed as the display panel 500. It is, however, to be understood that the present disclosure is not limited thereto.

The display panel 500 may include a light transmission area LTA overlapping an optical device OPD in the third direction DR3. The optical device OPD is an optical sensor that detects light, and may be, for example, a camera sensor, a proximity sensor, or an illuminance sensor. The light transmission area LTA may be a part of the display area DA.

The light transmission area LTA may include a transmissive area that allows light to pass. Alternatively, the light transmission area LTA may be a through hole penetrating the display panel. The transmittance of the light transmission area LTA may be higher than the transmittance of the display area DA excluding the light transmission area LTA. Due to the transmissive area of the light transmission area LTA, the density or integration degree of pixels in the light transmission area LTA may be lower than the density or integration degree of pixels in the display area DA excluding the light transmission area LTA. For example, the number of pixels per unit area in the light transmission area LTA may be smaller than the number of pixels per unit area in the display area DA excluding the light transmission area LTA. Alternatively, pixels per inch (PPI) in the light transmission area LTA may be smaller than PPI in the display area DA excluding the light transmission area LTA.

The second upper protection member 400 may be disposed on the front surface of the display panel 500. The second upper protection member 400 can mitigate shock to protect the display panel 500 from external impact. For example, the second upper protection member 400 may include a material having high flexibility and high rigidity.

The window member 200 may be attached to the front surface of the second upper protection member 400 by the first adhesive member 300. The window member 200 is made of a transparent material, and may be, for example, glass or plastic. For example, the window member 200 may be an ultra-thin glass (UTG) having a thickness of 0.1 mm or less or a transparent polyimide film.

The first adhesive member 300 may be a transparent adhesive film or a transparent adhesive resin. For example, the first adhesive member 300 may include a transparent adhesive such as a pressure sensitive adhesive (PSA) and an optically clear adhesive (OCA). The first adhesive member 300 may include an acrylic adhesive material.

The first upper protection member 100 may be disposed on the front surface of the window member 200. The first upper protection member 100 may perform at least one of functions of: shock absorption, anti-scratch, anti-fingerprint, anti-glare, and anti-scattering when the window member 200 is broken. For example, the first upper protection member 100 may include a material having high flexibility and resistance to scratches.

The lower protection member 600 may be disposed on the rear surface of the display panel 500. The lower protection member 600 may support the display panel 500 and protect the rear surface of the display panel 500. The lower protection member 600 may be made of plastic such as polyethylene terephthalate (PET) and polyimide.

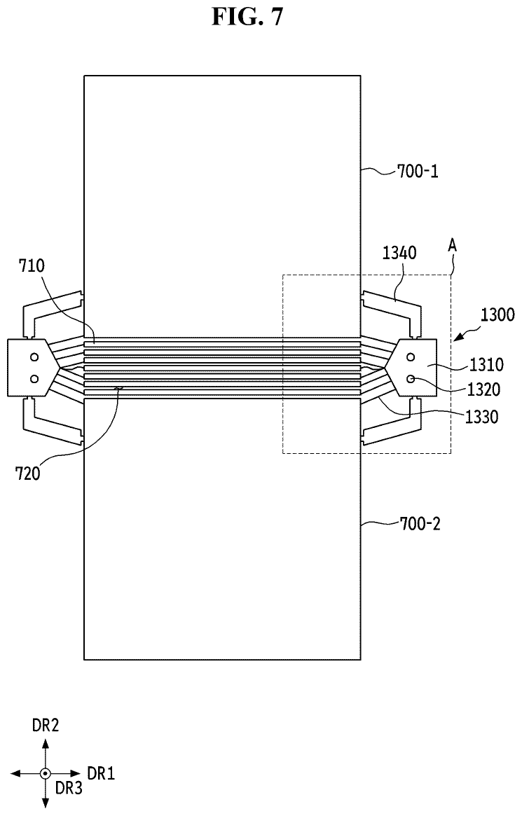

According to an embodiment of the present disclosure, in order to facilitate folding of the display device 10, at least a part of the lower protection member 600 may be removed from the folding area FDA of the display device 10. For example, as shown in FIG. 5, the lower protection member 600 may include a gap GAP in the folding area FDA. In some embodiments, the gap GAP may be formed at a lower surface of the lower protection member 600. The gap GAP may correspond to a recessed lower surface of the lower protection member 600. The lower surface, except for the recessed lower surface, of the lower protection member 600 may contact an upper surface of the panel support member 700. The recessed lower surface may be spaced apart from multiple bars 710 disposed in the folding area FDA. The multiple bars 710 will be described with reference to FIG. 7.

The gap GAP may be located adjacent to the upper surface of the panel support member 700. In the display device 10 according to this embodiment, since the lower protection member 600 includes the gap GAP, it is possible to prevent the panel support member 700 having high rigidity and the lower protection member 600 form being in direct contact with each other in the folding area FDA. By doing so, it is possible to reduce folding stress of the display device 10.

The panel support member 700 may be disposed on the rear surface of the lower protection member 600. The panel support member 700 may be a rigid member that does not easily change shape or volume due to external pressure. The panel support member 700 is disposed on the rear surface of the display panel 500 and is a rigid member that does not easily change its shape or volume due to external pressure, and thus it can support the display panel 500.

According to an embodiment of the present disclosure, the panel support member 700 may be a metal plate. For example, the panel support member 700 may be a metal plate and may be made of metal or metal alloy. The panel support member 700 may include, but is not limited to, copper (Cu), aluminum (Al), stainless steel (SUS), and/or an alloy thereof.

According to another embodiment, the panel support member 700 may be a polymer including carbon fiber or glass fiber. In this instance, since the panel support member 700 is formed of a polymer including carbon fiber or glass fiber, electromagnetic signals of a digitizer member in the display device 10 can pass through. Therefore, the panel support member 700 may be disposed that can support the display panel 500 without lowering the touch sensitivity of the digitizer member.

The panel support member 700 may include a through hole STH overlapping the optical device OPD in the third direction DR3. The through hole STH may overlap the light transmission area LTA of the display panel 500 in the third direction DR3. The area of the through hole STH may be greater than or equal to the area of the light transmission area LTA. The optical device OPD may detect light incident from the front of the display device 10 through the light transmission area LTA and the through hole STH. In some embodiments, the light transmission area LTA and the through hole STH may be connected with each other to enable the light to travel to the optical device OPD.

The panel support member 700 may include a folding portion so that it can be easily bent in the folding area FDA. As the panel support member 700 includes the folding portion disposed in the folding area FDA, the panel support member 700 can be easily bent when the display device 10 is folded.

The panel support member 700 will be described in detail with reference to FIG. 7 and the like.

The buffer member 800 can reduce folding stress of the panel support member 700 having high rigidity when the display device 10 is folded. The buffer member 800 may include a highly elastic material to absorb shock. For example, the buffer member 800 may include, but is not limited to, thermoplastic polyurethane (TPU).

In some embodiments, although not shown in the drawings, the display device 10 may further include a digitizer member (not shown). The digitizer member (not shown) may be disposed on the rear surface of the buffer member 800. The digitizer member (not shown) may include electrode patterns for sensing proximity or contact of an electronic pen such as a stylus pen supporting an electromagnetic resonance (EMR) technology. The digitizer member (not shown) may detect a magnetic field or an electromagnetic signal emitted from the electronic pen based on the electrode patterns, and may determine touch coordinates of the point where the detected magnetic field or electromagnetic signal is largest.

Magnetic metal powder may be disposed on the rear surface of the digitizer member (not shown). In this instance, a magnetic field or electromagnetic signal passing through the digitizer member (not shown) may flow into the magnetic metal powder. Therefore, by virtue of the magnetic metal powder, it is possible to reduce the amount of the magnetic field or the electromagnetic signal from the digitizer member (not shown) to the rear surface of the display device 10.

The lower functional member 1000 may be attached to the rear surface of the buffer member 800 by the second adhesive member 900A. The lower functional member 1000 may include at least one of: a light-blocking layer for absorbing light incident from outside; a buffer layer for absorbing external shock; and a heat sink layer for efficiently discharging heat from the display panel 500.

The light-blocking layer can block transmission of light, thereby preventing elements disposed under the light-blocking layer from being seen from above the display panel 500. The light-blocking layer may include a light-absorbing material such as a black pigment and a black dye.

The buffer layer can absorb external shock to prevent the display panel 500 from being damaged. The buffer layer may be made up of a single layer or multiple layers. For example, the buffer layer may be formed of a polymer resin such as polyurethane, polycarbonate, polypropylene and polyethylene, or may be formed of a material having elasticity such as a rubber and a sponge obtained by foaming a urethane-based material or an acrylic-based material.

The heat sink layer may include a first heat dissipation layer including graphite or carbon nanotubes, and a second heat dissipation layer formed of a thin metal film such as copper, nickel, ferrite and silver, which can block electromagnetic waves and have high thermal conductivity.

The second adhesive member 900A may be a transparent adhesive film or a transparent adhesive resin. For example, the second adhesive member 900A may include a transparent adhesive such as a pressure sensitive adhesive (PSA) and an optically clear adhesive (OCA). The second adhesive member 900A may include an acrylic adhesive material.

The second adhesive member 900A may not be disposed in the folding area FDA of the display device 10 to facilitate the folding of the display device 10. For example, the second adhesive member 900A may include a (2-1) adhesive member 910A disposed in the first non-folding area NFA1, and a (2-2) adhesive member 910B disposed in the second non-folding area NFA2. The (2-1) adhesive member 910A and the (2-2) adhesive member 910B may be spaced apart from each other with the folding area FDA therebetween.

The metal support member 1200 may be attached to the rear surface of the lower functional member 1000 by the third adhesive member 1100. The metal support member 1200 may include a material having high rigidity to support the lower functional member 1000. For example, the metal support member 1200 may include, but is not limited to, stainless steel such as SUS316.

The metal support member 1200 may not be disposed in the folding area FDA of the display device 10 to facilitate the folding of the display device 10. For example, the metal support member 1200 may include a first metal support member 1210 disposed in the first non-folding area NFA1, and a second metal support member 1220 disposed in the second non-folding area NFA2. The first metal support member 1210 and the second metal support member 1220 may be spaced apart from each other with the folding area FDA therebetween.

The third adhesive member 1100 may be a transparent adhesive film or a transparent adhesive resin. For example, the third adhesive member 1100 may include a transparent adhesive such as a pressure sensitive adhesive (PSA) and an optically clear adhesive (OCA). The third adhesive member 1100 may include an acrylic adhesive material.

The third adhesive member 1100 may not be disposed in the folding area FDA of the display device 10 to facilitate the folding of the display device 10. For example, the third adhesive member 1100 may include a (3-1) adhesive member 1110 disposed in the first non-folding area NFA1, and a (3-2) adhesive member 1120 disposed in the second non-folding area NFA2. The (3-1) adhesive member 1110 and the (3-2) adhesive member 1120 may be spaced apart from each other with the folding area FDA therebetween.

The anti-permeation member 1250 may be disposed on the rear surface of the buffer member 800. The anti-permeation member 1250 may be disposed between the buffer member 800 and the metal support member 1200 in the third direction DR3.

The anti-permeation member 1250 may be disposed at the edge of the buffer member 800. The anti-permeation member 1250 may be disposed on one side of the lower functional member 1000. Although the anti-permeation member 1250 is disposed at the edge of the buffer member 800 or on one side of the lower functional member 1000 only in the first direction DR1 in the drawings, but the present disclosure is not limited thereto. For example, the anti-permeation member 1250 may be disposed to surround the lower functional member 1000 on the plane in the first and second directions DR1 and DR2.

The anti-permeation member 1250 may be a waterproof (dust-proof) tape or a waterproof (dust-proof) member that attaches the rear surface of the buffer member 800 to the front surface of the metal support member 1200. Accordingly, it is possible to prevent permeation of moisture or dust into the display device 10 by the anti-permeation member 1250, and the display device 10 with waterproof and dustproof capabilities may be fabricated.

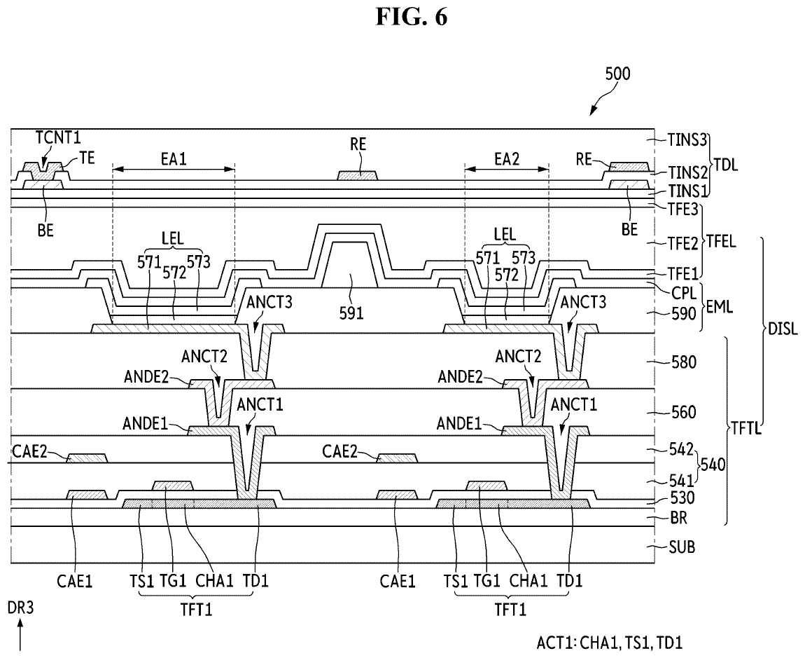

FIG. 6 is a schematic cross-sectional view of the display panel of FIG. 5.

Referring to FIG. 6, the display panel 500 may include a substrate SUB, a display layer DISL disposed on the substrate SUB, and a touch detecting layer TDL disposed on the display layer DISL. The display layer DISL may include a thin-film transistor layer TFTL, an emission material layer EML, and an encapsulation layer TFEL.

The thin-film transistor layer TFTL may be disposed on the substrate SUB. The thin-film transistor layer TFTL may include a barrier layer BR, a thin-film transistor TFT1, a first capacitor electrode CAE1, a second capacitor electrode CAE2, a first anode connection electrode ANDE1, a second anode connection electrode ANDE2, a gate insulator 530, a first interlayer dielectric film 541, a second interlayer dielectric film 542, a first planarization film 560, or a second planarization film 580.

The substrate SUB may be made of an insulating material such as a polymer resin. For example, the substrate SUB may be made of polyimide. The substrate SUB may be a flexible substrate that can be bent, folded, or rolled.

The barrier film BR may be disposed on the substrate SUB. The barrier film BR is a film for protecting the thin-film transistors of the thin-film transistor layer TFTL and an emissive layer 572 of the emission material layer EML. The barrier film BR may be made up of multiple inorganic films stacked on one another alternately. For example, the barrier film BR may be made up of multiple layers in which one or more inorganic layers of a silicon nitride layer, a silicon oxynitride layer, a silicon oxide layer, a titanium oxide layer and an aluminum oxide layer are alternately stacked on one another.

The thin-film transistors TFT1 may be disposed on the barrier film BR. An active layer ACT1 of the thin-film transistor TFT1 may be disposed on the barrier layer BR. The active layer ACT1 of the thin-film transistor TFT1 may include polycrystalline silicon, monocrystalline silicon, low-temperature polycrystalline silicon, amorphous silicon, or an oxide semiconductor.

The active layer ACT1 may include a channel region CHA1, a source region TS1 and a drain region TD1. The channel region CHA1 may overlap a gate electrode TG1 in the third direction DR3 that is the thickness direction of the substrate SUB. The source region TS1 may be disposed on one side of the channel region CHA1, and the drain region TD1 may be disposed on the opposite side of the channel region CHA1. The source region TS1 and the drain region TD1 may not overlap the gate electrode TG1 in the third direction DR3. The source region TS1 and the drain region TD1 may be formed by doping a silicon semiconductor or an oxide semiconductor with ions or impurities to have conductivity.

The gate insulator 530 may be disposed on the active layer ACT1 of the thin-film transistor TFT1. The gate insulator 530 may be formed of an inorganic layer, for example, a silicon nitride layer, a silicon oxynitride layer, a silicon oxide layer, a titanium oxide layer, or an aluminum oxide layer.

The gate electrode TG1 of the thin-film transistor TFT1 and the first capacitor electrode CAE1 may be disposed on the gate insulator 530. The gate electrode TG1 may overlap the channel region CHA1 in the third direction DR3. Although the gate electrode TG1 and the first capacitor electrode CAE1 are spaced apart from each other in the example shown in FIG. 6, the gate electrode TG1 and the first capacitor electrode CAE1 may be connected with each other as a single piece. The gate electrode TG1 and the first capacitor electrode CAE1 may be made up of a single layer of one of molybdenum (Mo), aluminum (Al), chromium (Cr), gold (Au), titanium (Ti), nickel (Ni), neodymium (Nd), copper (Cu), and an alloy thereof or a multiple layers of at least two of molybdenum (Mo), aluminum (Al), chromium (Cr), gold (Au), titanium (Ti), nickel (Ni), neodymium (Nd), copper (Cu), and an alloy thereof.

The first interlayer dielectric film 141 may be disposed on the gate electrode TG1 of the thin-film transistor TFT1 and the first capacitor electrode CAE1. The first interlayer dielectric film 541 may be formed of an inorganic layer, for example, a silicon nitride layer, a silicon oxynitride layer, a silicon oxide layer, a titanium oxide layer, or an aluminum oxide layer. The first interlayer dielectric film 541 may be made of a plurality of inorganic films.

The second capacitor electrode CAE2 may be disposed on the first interlayer dielectric film 541. The second capacitor electrode CAE2 may overlap the first capacitor electrode CAE1 of the thin-film transistor TFT1 in the third direction DR3. When the gate electrode TG1 and the first capacitor electrode CAE1 are formed as a single piece, the second capacitor electrode CAE2 may overlap the gate electrode TG1 in the third direction DR3. Since the first interlayer dielectric film 541 has a predetermined dielectric constant, a capacitor can be formed by the first capacitor electrode CAE1, the second capacitor electrode CAE2 and the first interlayer dielectric film 541 disposed therebetween. The second capacitor electrode CAE2 may be made up of a single layer of one of molybdenum (Mo), aluminum (Al), chromium (Cr), gold (Au), titanium (Ti), nickel (Ni), neodymium (Nd), copper (Cu), and an alloy thereof or multiple layers of at least two of molybdenum (Mo), aluminum (Al), chromium (Cr), gold (Au), titanium (Ti), nickel (Ni), neodymium (Nd) and copper (Cu), and an alloy thereof.

The second interlayer dielectric film 542 may be disposed over the second capacitor electrode CAE2. The second interlayer dielectric film 542 may be formed of an inorganic layer, for example, a silicon nitride layer, a silicon oxynitride layer, a silicon oxide layer, a titanium oxide layer, or an aluminum oxide layer. The second interlayer dielectric film 542 may be made of a plurality of inorganic films.

A first anode connection electrode ANDE1 may be disposed on the second interlayer dielectric film 542. The first anode connection electrode ANDE1 may be connected to the drain electrode DT1 of the thin-film transistor TFT1 through a first connection contact hole ANCT1 that penetrates the gate insulator 530, the first interlayer dielectric film 541 and the second interlayer dielectric film 542. The first anode connection electrode ANDE1 may be made up of a single layer of one of molybdenum (Mo), aluminum (Al), chromium (Cr), gold (Au), titanium (Ti), nickel (Ni), neodymium (Nd), copper (Cu), and an alloy thereof or multiple layers of at least two of molybdenum (Mo), aluminum (Al), chromium (Cr), gold (Au), titanium (Ti), nickel (Ni), neodymium (Nd), copper (Cu), and an alloy thereof.

The first planarization film 560 may be disposed over the first anode connection electrode ANDE1 for providing a flat surface over level differences due to the thin-film transistor TFT1. The first planarization film 560 may be formed of an organic layer such as an acryl resin, an epoxy resin, a phenolic resin, a polyamide resin and a polyimide resin.

A second anode connection electrode ANDE2 may be disposed on the first planarization film 560. The second anode connection electrode ANDE2 may be connected to the first anode connection electrode ANDE1 through a second connection contact hole ANCT2 penetrating the first planarization film 560. The second anode connection electrode ANDE2 may be made up of a single layer one of molybdenum (Mo), aluminum (Al), chromium (Cr), gold (Au), titanium (Ti), nickel (Ni), neodymium (Nd), copper (Cu), and an alloy thereof or multiple layers of at least two of molybdenum (Mo), aluminum (Al), chromium (Cr), gold (Au), titanium (Ti), nickel (Ni), neodymium (Nd), copper (Cu), and an alloy thereof.

A second planarization film 580 may be disposed on the second anode connection electrode ANDE2. The second planarization film 580 may be formed as an organic layer such as an acryl resin, an epoxy resin, a phenolic resin, a polyamide resin and a polyimide resin.

An emission material layer EML including light-emitting elements LEL and a bank 590 may be disposed on the second planarization film 580. Each of the light-emitting elements LEL includes a pixel electrode 571, an emissive layer 572, and a common electrode 573.

The pixel electrode 571 may be disposed on the second planarization film 580. The pixel electrode 571 may be connected to the second anode connection electrode ANDE2 through a third connection contact hole ANCT3 penetrating the second planarization film 580.

In the top-emission structure in which light is emitted from the emissive layer 572 toward the common electrode 573, the pixel electrode 571 may be made of a metal material having a high reflectivity such as a stack structure of aluminum and titanium (Ti/Al/Ti), a stack structure of aluminum (Al) and ITO (Indium Tin Oxide) (ITO/Al/ITO), an APC alloy and a stack structure of an APC alloy and ITO (ITO/APC/ITO). The APC alloy is an alloy of silver (Ag), palladium (Pd) and copper (Cu).

The bank 590 may partition the pixel electrode 571 on the second planarization film 580 to define the emission areas EA1 and EA2. The bank 590 may be disposed to cover the edges of the pixel electrode 571. The bank 590 may be formed of an organic film such as an acryl resin, an epoxy resin, a phenolic resin, a polyamide resin and a polyimide resin.

In each of the first emission area EA1 and the second emission area EA2, the pixel electrode 571, the emissive layer 572 and the common electrode 573 are stacked on one another sequentially, so that holes from the pixel electrode 571 and electrons from the common electrode 573 are recombined with each other in the emissive layer 572 to emit light.

The emissive layer 572 may be disposed on the pixel electrode 571 and the bank 590. The emissive layer 572 may include an organic material to emit light of a certain color. For example, the emissive layer 572 may include a hole transporting layer, an organic material layer, and an electron transporting layer.

The common electrode 573 may be disposed on the emissive layer 572. The common electrode 573 may be disposed to cover the emissive layer 572. The common electrode 573 may be a common layer formed commonly across the first emission area EA1 and the second emission area EA2.

In the top-emission organic light-emitting diode, the common electrode 573 may be formed of a transparent conductive material (TCP) such as ITO and IZO that can transmit light, or a semi-transmissive conductive material such as magnesium (Mg), silver (Ag) and an alloy of magnesium (Mg) and silver (Ag). When the common electrode 173 is formed of a semi-transmissive metal material, the light extraction efficiency can be increased by using microcavities.

A spacer 591 may be disposed on the bank 590. The spacer 591 may support a mask during a process of fabricating the emissive layer 572. The spacer 591 may be formed of an organic layer such as an acryl resin, an epoxy resin, a phenolic resin, a polyamide resin and a polyimide resin.

According to some embodiments of the present disclosure, the display panel 500 may further include a capping layer CPL disposed on the common electrode 573. The capping layer CPL may be made of an inorganic material. For example, the capping layer CPL may include at least one of: silicon nitride, aluminum nitride, zirconium nitride, titanium nitride, hafnium nitride, tantalum nitride, silicon oxide, aluminum oxide, titanium oxide, tin oxide, cerium oxide and silicon oxynitride.

An encapsulation layer TFEL may be disposed on the common electrode 573. The encapsulation layer TFEL may include at least one inorganic layer to prevent permeation of oxygen or moisture into the emission material layer EML. The encapsulation layer TFEL may include at least one organic film to protect the emission material layer EML from particles such as dust. For example, the encapsulation layer TFEL may include a first inorganic encapsulation layer TFE1, an organic encapsulation layer TFE2 and a second inorganic encapsulation layer TFE3.

The first inorganic encapsulation film TFE1 may be disposed on the common electrode 573, the organic encapsulation film TFE2 may be disposed on the first inorganic encapsulation film TFE1, and the second inorganic encapsulation film TFE3 may be disposed on the organic encapsulation film TFE2. The first inorganic encapsulation film TFE1 and the second inorganic encapsulation film TFE3 may be made up of multiple layers in which one or more inorganic layers of a silicon nitride layer, a silicon oxynitride layer, a silicon oxide layer, a titanium oxide layer and an aluminum oxide layer are alternately stacked on one another. The organic encapsulation film TFE2 may be an organic film such as an acryl resin, an epoxy resin, a phenolic resin, a polyamide resin, and a polyimide resin.

A touch detecting layer TDL may be disposed on the encapsulation layer TFEL. The touch detecting layer TDL includes a first touch insulating film TINS1, connection electrodes BE, a second touch insulating film TINS2, the driving electrodes TE, the sensing electrodes RE, and a third touch insulating film TINS3.

The first touch insulating film TINS1 may be disposed on the encapsulation layer TFEL. The first touch insulating film TINS1 may be formed of an inorganic film, for example, a silicon nitride layer, a silicon oxynitride layer, a silicon oxide layer, a titanium oxide layer, or an aluminum oxide layer.

The connection electrode BE may be disposed on the first touch insulating film TINS1. The connection electrode BE may be made up of a single layer one of molybdenum (Mo), aluminum (Al), chromium (Cr), gold (Au), titanium (Ti), nickel (Ni), neodymium (Nd), copper (Cu) and an alloy thereof or multiple layers of at least two of molybdenum (Mo), aluminum (Al), chromium (Cr), gold (Au), titanium (Ti), nickel (Ni), neodymium (Nd), copper (Cu), and an alloy thereof.

The second touch insulating film TINS2 may be disposed over the connection electrodes BE. The second touch insulating layer TINS2 may be formed of an inorganic layer, for example, a silicon nitride layer, a silicon oxynitride layer, a silicon oxide layer, a titanium oxide layer, or an aluminum oxide layer. Alternatively, the second touch insulating layer TINS2 may be formed of an organic layer such as an acryl resin, an epoxy resin, a phenolic resin, a polyamide resin and a polyimide resin.

The driving electrodes TE and the sensing electrodes RE may be disposed on the second touch insulating film TINS2. The driving electrodes TE and the sensing electrodes RE may be made up of a single layer of one of molybdenum (Mo), aluminum (Al), chromium (Cr), gold (Au), titanium (Ti), nickel (Ni), neodymium (Nd), copper (Cu), and an alloy thereof or multiple layers of at least two of molybdenum (Mo), aluminum (Al), chromium (Cr), gold (Au), titanium (Ti), nickel (Ni), neodymium (Nd), copper (Cu), and an alloy thereof.

The driving electrodes TE and the sensing electrodes RE may overlap the connection electrodes BE in the third direction DR3. The driving electrodes TE may be connected to the connection electrodes BE through touch contact holes TCNT1 penetrating through the first touch insulating film TINS1.

The third touch insulating film TINS3 may be formed on the driving electrodes TE and the sensing electrodes RE. The third touch insulating layer TINS3 may provide a flat surface over the driving electrodes TE, the sensing electrodes RE and the connection electrodes BE which have different heights. The third touch insulating film TINS3 may be formed of an organic layer such as an acryl resin, an epoxy resin, a phenolic resin, a polyamide resin and a polyimide resin.

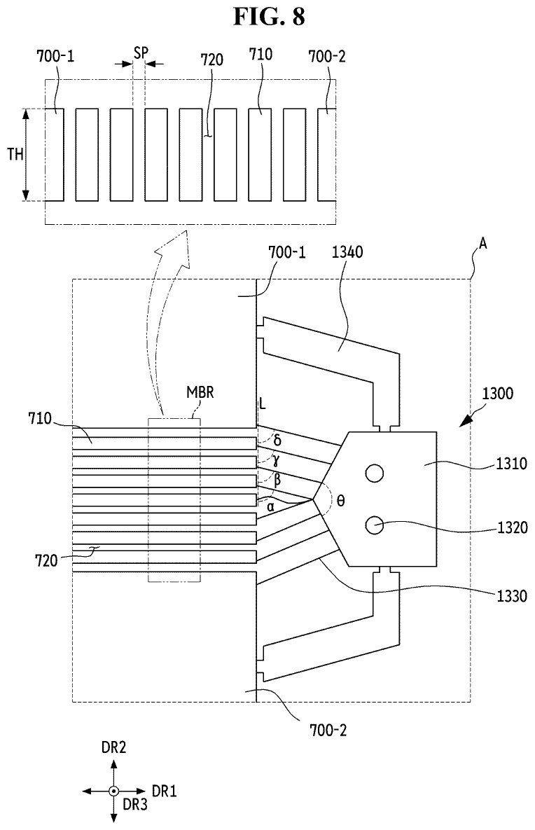

FIG. 7 is a plan view showing a panel support member of a display device according to an embodiment of the present disclosure with a distance adjuster connected thereto. FIG. 8 is an enlarged view of portion A of FIG. 7.

Referring to FIGS. 7 and 8, the panel support member 700 may extend lengthwise in a direction. The direction may be the second direction DR2 in the drawings. The panel support member 700 may include a folding portion, a first non-folding portion 700-1, a second non-folding portion 700-2, and multiple bars 710. The folding portion may be located in the folding area FDA, the first non-folding portion 700-1 may be located in the first non-folding area NFA1, and the second non-folding portion 700-2 may be located in the second non-folding area NFA2.

The folding portion may be folded when the display device 10 is folded. The folding portion may be located between the first non-folding portion 700-1 and the second non-folding portion 700-2 in the second direction DR2.

The first non-folding portion 700-1 and the second non-folding portion 700-2 may not be folded when the display device 10 is folded. The first non-folding portion 700-1 may be located on one side of the folding portion in the second direction DR2, and the second non-folding portion 700-2 may be located on the opposite side of the folding portion in the second direction DR2.

The multiple bars 710 may be disposed in the folding portion. In other words, the multiple bars 710 may be disposed between the first non-folding portion 700-1 and the second non-folding portion 700-2. The multiple bars 710 may be spaced apart from one another. As the multiple bars 710 are spaced apart from each other, spaces 720 may be formed between the multiple bars 710.

The multiple bars 710 may extend lengthwise in a direction perpendicular to the direction in which the panel support member 700 extends lengthwise. For example, the multiple bars 710 may be spaced apart from each other in the second direction DR2, and each of the multiple bars 710 may extend lengthwise in the first direction DR1. The length, in the first direction, of the multiple bars 710 may be equal to the length of the panel support member 700 in the first direction DR1. For example, the panel support member 700 may have shorter sides extended in the first direction DR1 and longer sides extended in the second direction DR2, and the length of the multiple bars 710 may be equal to the length of the shorter sides of the panel support member 700. In some embodiments, the multiple bars 710 may have the same length in the first direction DR1.

The spaces 720 may be formed between the multiple bars 710, between the first non-folding portion 700-1 and the multiple bars 710, and between the second non-folding portion 700-2 and the multiple bars 710. In some embodiments, a first space may be formed between the first non-folding portion 700-1 and a first outermost bar among the multiple bars 710 (e.g., the uppermost bar on FIG. 7), and multiple second spaces may be formed between two adjacent bars among the multiple bars 710, and a third space may be formed between the second non-folding portion 700-2 and a second outermost bar among the multiple bars 710 (e.g., the lowermost bar on FIG. 7). The length of the spaces 720 in the first direction DR1 may be equal to the length of the shorter sides of the panel support member 700 or the length of the multiple bars 710 in the first direction DR1. In some embodiments, the first space, the multiple spaces, and the third space may have the same width in the second direction DR2 and the same length in the first direction DR1.

The display device 10 may further include a distance adjuster 1300. The distance adjuster 1300 may adjust the widths of the spaces 720 in the second direction DR2 formed in the folding portion of the panel support member 700. The distance adjuster 1300 may adjust the widths, in the second direction DR2, of the spaces 720 formed in the panel support member 700 during the process of fabricating the display device 10. Specifically, the distance adjuster 1300 may adjust the widths, in the second direction DR2, of the spaces 720 of the panel support member 700 before the lower protection member 600 is stacked on the panel support member 700. The distance adjuster 1300 may be removed from the panel support member 700 after the lower protection member 600 is stacked on the panel support member 700.

There may be a plurality of distance adjusters 1300 disposed on opposite sides, in the first direction DR1, of the panel support member 700, respectively. For example, the plurality of distance adjusters 1300 may include a first distance adjuster and a second distance adjuster. The first distance adjuster may be disposed on the right side of the panel support member 700 in FIG. 7, and the second distance adjuster may be disposed on the left side, opposite to the right side in the first direction DR1, of the panel support member 700 in FIG. 7. Hereinafter, only the first distance adjuster unit will be described for the convenience of illustration. The second distance adjuster may have the same configuration as the first distance adjuster, except for its position.

The distance adjuster 1300 may include a moving member 1310, an alignment hole 1320, a connecting wire 1330, and a bridge 1340.

The moving member 1310 may be disposed on a side of the panel support member 700 and may move in the direction (e.g., in the first direction DR1) in which the multiple bars 710 extend lengthwise. For example, the moving member 1310 that is attached to the side of the panel support member 700 may be moved in the first direction DR1. In some embodiments, the moving member 1310 may be pulled away in a direction away from the multiple bars 710 which is parallel to the first direction DR1. The moving member 1310 may be located on a line extended from the folding portion of the panel support member 700.

When the moving member 1310 is viewed from the top, the end portion of the moving member 1310 closer to the panel support member 700 may protrude toward the panel support member 700. The angle θ of the end portion of the moving member 1310 that protrudes toward the panel support member 700 may be equal to or less 180°. In some embodiments, the end portion of the moving member 1310 may have a shape of isosceles triangle. Two sides of the isosceles-triangle shaped portion of the moving member 1310 which have the same length may be adjacent to the support member 700. An angle between the two sides may be an angle greater than 90° and smaller than 180°. In some embodiment, a vertex between the two sides and a center bar of the multiple bars 710 may be aligned with each other in the first direction DR1.

A plurality of alignment holes 1320 may be formed in the moving member 1310. The alignment holes 1320 may penetrate the moving member 1310 in the thickness direction of the moving member 1310. The alignment holes 1320 may be spaced apart from each other in the second direction DR2 in the moving member 1310.

The connecting wire 1330 may connect each of the first non-folding portion 700-1, the second non-folding portion 700-2 and the multiple bars 710 with the moving member 1310. For example, there may be a plurality of connecting wires 1330. The first connecting wire 1330 may connect the first non-folding portion 700-1 with the moving member 1310, and the second connecting wire 1330 may connect one of the multiple bars 710 with the moving member 1310. A third connecting wire 1330 may connect another bar 710 next to the bar 710 connected to the second connecting wire 1330 with and the moving member 1310. In this manner, the connecting wires 1330 may connect all of the multiple bars 710 with the moving member 1310, and then the nth connecting wire 1330 may connect the second non-folding portion 700-2 with the moving member 1310. The connecting wires 1330 may be formed in a straight line and may connect each of the first non-folding portion 700-1, the second non-folding portion 700-2 and the multiple bars 710 with the moving member 1310.

Among the angles formed by the connecting wires 1330 and a virtual reference line L extended in parallel to the direction in which the panel support member 700 is extended, acute angles may gradually increase from the center of the folding portion to the outer side of the folding portion in the direction in which the panel support member 700 is extended. For example, the acute angle δ formed by the reference line L and the connecting wire 1330 connecting the first non-folding portion 700-1 with the moving member 1310 may be greater than the acute angle α formed by the reference line L and the connecting wire 1330 connecting the bar 710 located at the center of the folding portion with the moving member 1310. In other words, the acute angles α, β, γ and δ formed by the connecting wires 1330 and the reference line L may gradually increase from α to δ.

The bridge 1340 may connect the first non-folding portion 700-1, the second non-folding portion 700-2 and the moving member 1310 with one another. In some embodiments, the moving member 1310 may further include a rectangular-shaped portion in addition to the isosceles-triangle shaped portion. The bridge 1340 may be connected to upper and lower sides of the rectangular-shaped portion which are spaced apart from each other in the second direction DR2. There may be a plurality of bridges 1340. The bridges 1340 may include a first bridge 1340 and a second bridge 1340. The first bridge 1340 may connect the first non-folding portion 700-1 with the moving member 1310, and the second bridge 1340 may connect the second non-folding portion 700-2 with the moving member 1310.

In some embodiments, a width SP, in the second direction DR2, of the spaces SP may be less than a half of the thickness TH. The width SP may be equal to or less 50 μm.

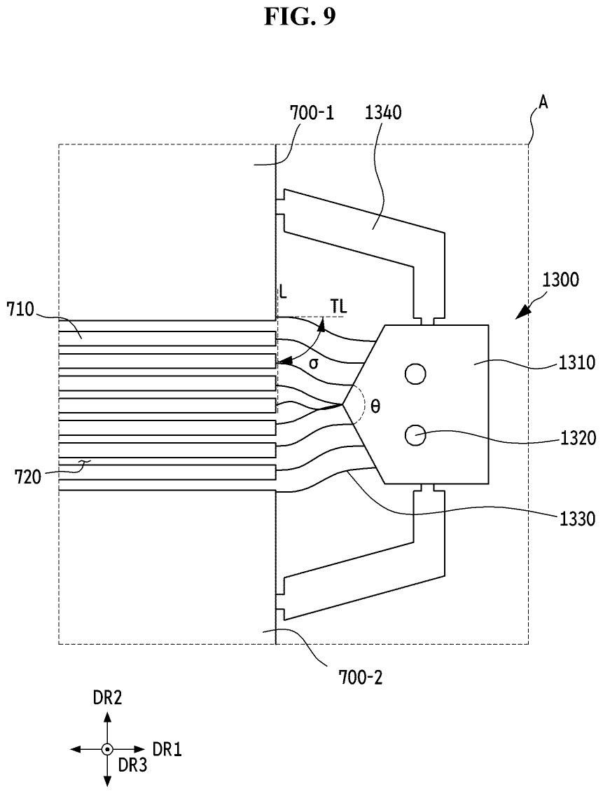

FIG. 9 is a view showing a modification of the embodiment shown in FIG. 8. The distance adjuster 1300 of FIG. 9 is substantially identical to the distance adjuster 1300 of FIG. 8 except for the shape of connecting wires 1330. The redundant descriptions will be omitted.

Referring to FIG. 9, connecting wires 1330 may connect each of the first non-folding portion 700-1, the second non-folding portion 700-2 and the multiple bars 710 with the moving member 1310. For example, there may be a plurality of connecting wires 1330. The first connecting wire 1330 may connect the first non-folding portion 700-1 with the moving member 1310, and the second connecting wire 1330 may connect one of the multiple bars 710 with the moving member 1310. A third connecting wire 1330 may connect another bar 710 next to the bar 710 connected to the second connecting wire 1330 with the moving member 1310. In this manner, the connecting wires 1330 may connect all of the multiple bars 710 with the moving member 1310, and then the nth connecting wire 1330 may connect the second non-folding portion 700-2 with the moving member 1310. The connecting wires 1330 may be formed in a curved line and may connect the first non-folding portion 700-1, the second non-folding portion 700-2 and the multiple bars 710 with the moving member 1310.

The angles σ formed by a virtual reference line L extended in parallel to the direction in which the panel support member 700 is extended, and virtual tangent lines TL that touch the connecting wires 1330 where the connecting wires 1330 are connected to the first non-folding portion 700-1, the second non-folding portion 700-2 and the multiple bars 710 may be equal to or less than 90°. In other words, the connecting wires 1330 may be curved and extended toward the center of the folding area FDA from the first non-folding portion 700-1, the second non-folding portion 700-2 and the multiple bars 710 to be connected to the moving member 1310. The connecting wires 1330 may be curved toward the center of the folding area FDA from the first non-folding portion 700-1, the second non-folding portion 700-2 and the multiple bars 710 and then may be curved again and extended toward the moving member 1310, to be connected to the moving member 1310.

Hereinafter, a method of fabricating a display device 10 according to an embodiment of the present disclosure will be described with reference to the accompanying drawings. According to the method of fabricating a display device 10 described herein, the widths, in the second direction DR2, of the spaces 720 formed in a panel support member 700 is reduced by a distance adjuster 1300, and then the lower protection member 600 is stacked on the panel support member 700. The other processes are identical to those well known in the art and thus will not be described for the sake of brevity.

Initially, the panel support member 700 may be prepared, which includes a folding portion and multiple bars 710 that are spaced apart from each other in the folding portion to form the spaces 720. The panel support member 700 may include a first non-folding portion 700-1 and a second non-folding portion 700-2, and the folding portion may be located between the first non-folding portion 700-1 and the second non-folding portion 700-2.

Once the panel support member 700 is prepared, the distance adjusters 1300 may be respectively disposed on opposite sides of the prepared panel support member 700 in the first direction DR1. The distance adjusters 1300 disposed on the opposite sides of the panel support member 700 may be connected to the panel support member 700.

The distance adjuster 1300 may be connected to the first non-folding portion 700-1, the second non-folding portion 700-2 and multiple bars 710 of the panel support member 700. A way how the distance adjuster 1300 is connected to the panel support member 700 will be described. Initially, connecting wires 1330 may be connected to the first non-folding portion 700-1, the second non-folding portion 700-2 and multiple bars 710, respectively. The connecting wires 1330 connected to the first non-folding portion 700-1, the second non-folding portion 700-2 and the multiple bars 710, respectively, may be connected to the moving member 1310. Once the moving member 1310 is connected to the panel support member 700 by the connecting wire 1330, bridges 1340 may connect the first non-folding portion 700-1 and the second non-folding portion 700-2 with the moving member 1310.

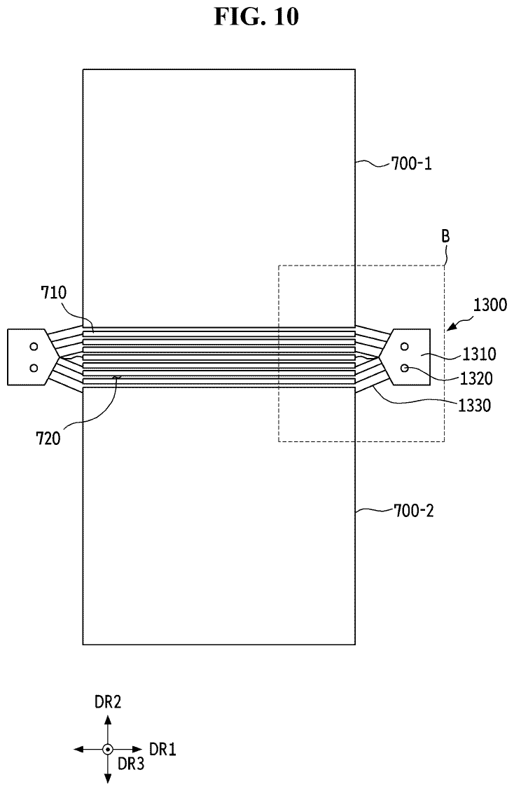

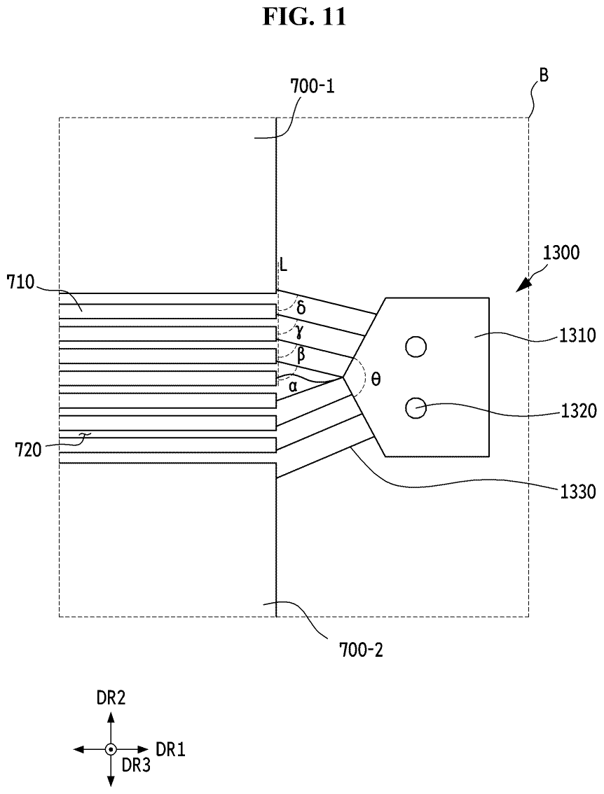

FIG. 10 is a plan view showing the panel support member of FIG. 7 after the bridges of the distance adjuster have been removed. FIG. 11 is an enlarged view of portion B of FIG. 10.

Referring to FIGS. 10 and 11, after the distance adjuster 1300 is connected to the panel support member 700, the panel support member 700 having the distance adjuster 1300 connected thereto may be placed on a stacking jig (not shown). Once the panel support member 700 is placed on the stacking jig, the bridge 1340 may be removed from the panel support member 700. In other words, the bridge 1340 connecting the first non-folding portion 700-1 with the moving member 1310 and the bridge 1340 connecting the second non-folding portion 700-2 with the moving member 1310 may be removed.

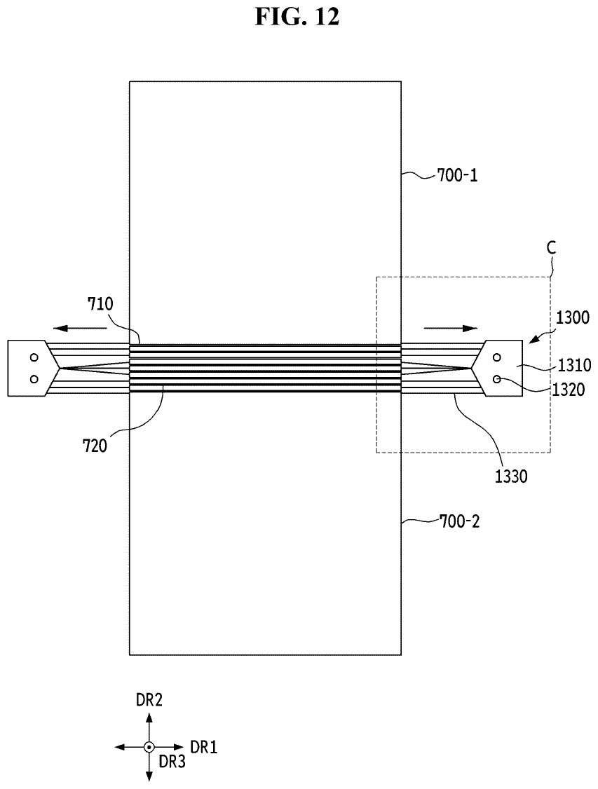

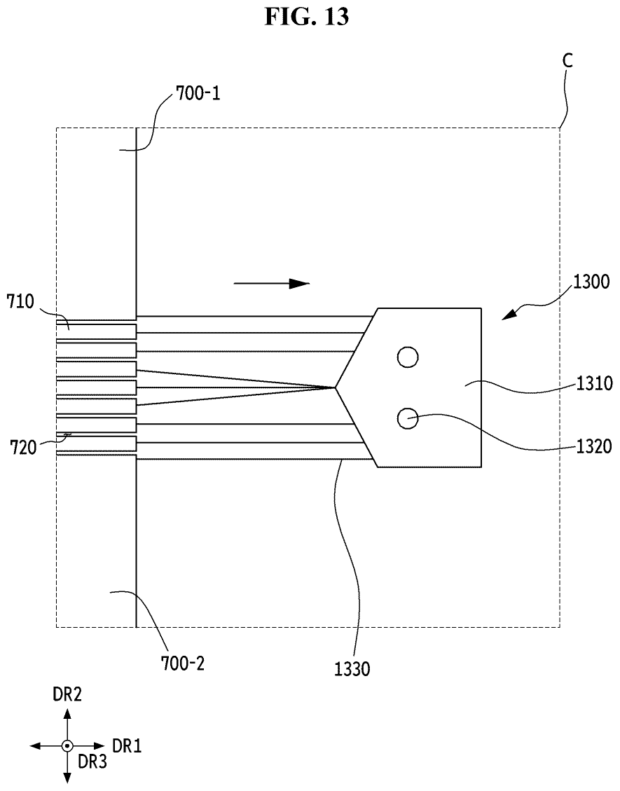

FIG. 12 is a plan view showing the panel support member of FIG. 10 when the moving member of the distance adjuster is moved. FIG. 13 is an enlarged view of portion C of FIG. 12.

Referring to FIGS. 12 and 13, after the bridge 1340 has been removed from the panel support member 700, the moving member 1310 may be moved to reduce the spaces 720 of the panel support member 700. The moving member 1310 disposed on the right side of the panel support member 700 in FIG. 12 is referred to as a first moving member 1310, and the moving member 1310 disposed on the left side in FIG. 12 is referred to as a second moving member 1310. The first moving member 1310 and the second moving member 1310 may be moved in the opposite directions which are parallel to the first direction DR1.

As the first moving member 1310 and the second moving member 1310 are moved in the opposite directions, the first non-folding portion 700-1, the second non-folding portion 700-2 and the multiple bars 710 are pulled in different directions by the connecting wires 1330, so that the first non-folding portion 700-1, the second non-folding portion 700-2 and the multiple bars 710 may be moved in the second direction DR2. The moving member 1310 may be moved until one or more of the connecting wires 1330 are parallel to the multiple bars 710. In this manner, the first non-folding portion 700-1, the second non-folding portion 700-2 and the multiple bars 710 are moved in the second direction DR2 by the movement of the first moving member 1310 and the second moving member 1310, so that the spaces 720 formed in the panel support member 700 can be reduced. The reduced widths, in the second direction DR2, of the spaces 720 may be equal to or less 50 μm.

In the process of reducing the spaces 720 formed in the panel support member 700, it is possible to check whether the alignment holes 1320 formed in the first moving member 1310 and the second moving member 1310 are positioned parallel to each other. As long as the alignment holes 1320 formed in the first moving member 1310 and the second moving member 1310 are located in parallel to each other, the multiple bars 710 are not dislocated and the spaces 720 can be reduced properly. For example, when the alignment holes 1320 of the first moving member 1310 (e.g., the left first moving member in FIG. 7) and the alignment holes 1320 of the second moving member 1310 (e.g., the right first moving member in FIG. 7) are aligned parallel to the first direction DR1 after pulling the first and second moving members 1310 in opposite directions, such pulling can be properly executed to effectively reduce the spaces 720.

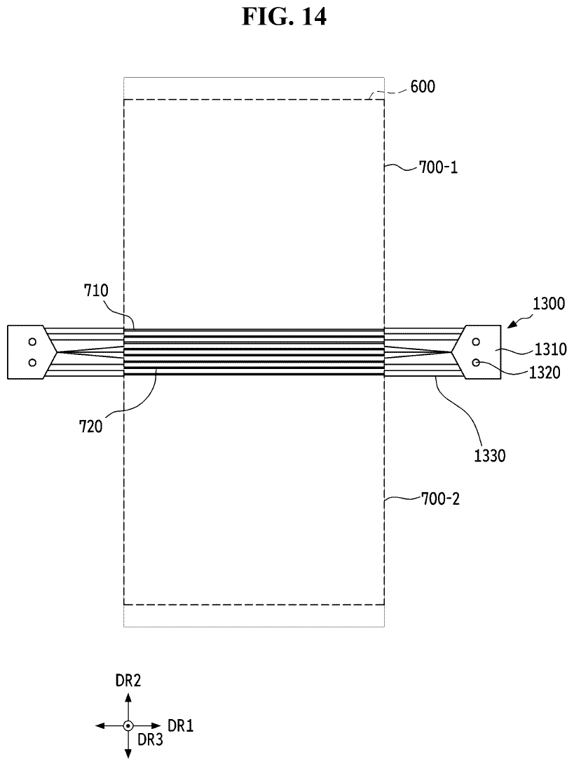

FIG. 14 is a plan view showing the panel support member of FIG. 12 when a lower protection member is stacked on it.

Referring to FIG. 14, after the spaces 720 formed in the panel support member 700 are reduced by the distance adjuster 1300, a lower protection member 600 may be stacked on a surface of the panel support member 700. A separate adhesive layer may be provided between the panel support member 700 and the lower protection member 600, and the lower protection member 600 may be attached to the surface of the panel support member 700 by the adhesive layer.

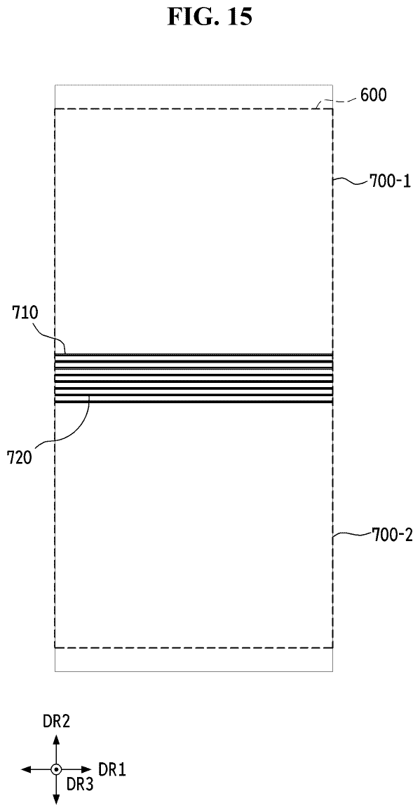

FIG. 15 is a plan view showing the panel support member of FIG. 14 after the distance adjuster has been removed.

Referring to FIG. 15, after the lower protection member 600 is stacked on the surface of the panel support member 700, the distance adjuster 1300 may be removed from the panel support member 700. Even after the distance adjuster 1300 is removed from the panel support member 700, the spaces 720 formed in the panel support member 700 can remain reduced because the lower protection member 600 is attached to the panel support member 700.

After the distance adjuster 1300 has been removed from the panel support member 700, the subsequent processes of fabricating the display device 10 may be performed.

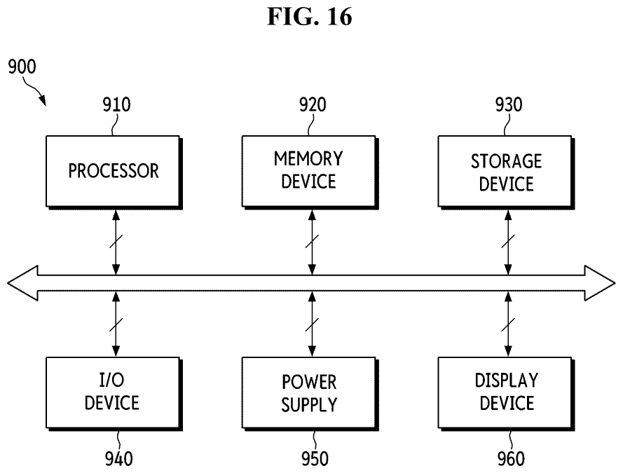

FIG. 16 is a block diagram illustrating an electronic device according to an embodiment.

Referring to FIG. 16, an electronic device 900 may include a processor 910, a memory device 920, a storage device 930, an input/output (“I/O”) device 940, a power supply 950, and a display device 960. Here, the display device 960 may correspond to the display device DD of FIG. 1. The electronic device 900 may further include a plurality of ports for communicating with a video card, a sound card, a memory card, a universal serial bus (“USB”) device, or the like. In an embodiment, the electronic device 900 may be implemented as a television. In another embodiment, the electronic device 900 may be implemented as a smart phone. However, embodiments are not limited thereto, in another embodiment, the electronic device 900 may be implemented as a cellular phone, a video phone, a smart pad, a smart watch, a tablet personal computer (“PC”), a car navigation system, a computer monitor, a laptop, a head disposed (e.g., mounted) display (“HMD”), or the like.

The processor 910 may perform various computing functions. In an embodiment, the processor 910 may be a microprocessor, a central processing unit (“CPU”), an application processor (“AP”), or the like. The processor 910 may be coupled to other components via an address bus, a control bus, a data bus, or the like. In an embodiment, the processor 910 may be coupled to an extended bus such as a peripheral component interconnection (“PCI”) bus.

The memory device 920 may store data for operations of the electronic device 900. In an embodiment, the memory device 920 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, or the like, and/or at least one volatile memory device such as a dynamic random access memory (“DRAM”) device, a static random access memory (“SRAM”) device, a mobile DRAM device, or the like.

In an embodiment, the storage device 930 may include a solid state drive (“SSD”) device, a hard disk drive (“HDD”) device, a CD-ROM device, or the like. In an embodiment, the I/O device 940 may include an input device such as a keyboard, a keypad, a mouse device, a touchpad, a touch-screen, or the like, and an output device such as a printer, a speaker, or the like.

The power supply 950 may provide power for operations of the electronic device 900. The power supply 950 may provide power to the display device 960. The display device 960 may be coupled to other components via the buses or other communication links. In an embodiment, the display device 960 may be included in the I/O device 940.

While the present disclosure has been described with reference to an embodiment thereof, it will be apparent to those of ordinary skill in the art that various changes and modifications may be made thereto without departing from the spirit and scope of the present disclosure as set forth in the following claims. Accordingly, the technical scope of the present disclosure should not be limited to the contents described in the detailed description of the specification, but should be defined by the claims.

What is claimed is:

1. A display device comprising:
a display panel comprising a folding area; and
a panel support member disposed on a surface of the display panel,
wherein the panel support member comprises:
a folding portion overlapping the folding area; and
multiple bars spaced apart from each other in the folding portion.

2. The display device of claim 1,
wherein each bar of the multiple bars extends lengthwise in a first direction and the multiple bars are spaced apart from each other in a second direction perpendicular to the first direction, and
wherein the panel support member extends lengthwise in the second direction.

3. The display device of claim 2,
wherein the panel support member has longer sides extending in the second direction, and shorter sides extending in the first direction, and
wherein a length of the multiple bars in the first direction is equal to a length of the shorter sides of the panel support member.

4. The display device of claim 2,
wherein the panel support member further comprises:
a first non-folding portion; and
a second non-folding portion spaced apart from the first non-folding portion,
wherein the folding portion is located between the first non-folding portion and the second non-folding portion, and
wherein a first space is formed between the first non-folding portion and a first outermost bar of the multiple bars, multiple second spaces are formed between two adjacent multiple bars of the multiple bars, and a third space is formed between the second non-folding portion and a second outermost bar of the multiple bars.

5. The display device of claim 4,
wherein a length of the first space in the first direction is equal to a length of the multiple bars in the first direction.

6. The display device of claim 4,
wherein the first space, the third space, and each of the multiple second spaces have the same width in the second direction and the same length in the first direction.

7. The display device of claim 4,
wherein a width of the first space in the second direction is less than a half of a thickness of the first outermost bar in a third direction perpendicular to the first and second directions.

8. The display device of claim 7, further comprising:
a lower protection member disposed between the display panel and the panel support member,
wherein the lower protection member is attached to the panel support member and is configured to maintain the first space, the multiple second spaces, and the third space.

9. The display device of claim 8,
wherein the lower protection member has a recessed surface at a lower surface,
wherein the lower surface except for the recessed surface contacts the panel support member, and
wherein the recessed surface is spaced apart from a region where the multiple bars are disposed.

10. A method of fabricating a display device, the method comprising:
preparing a panel support member comprising a folding portion and multiple bars spaced apart from each other in the folding portion to form spaces;
connecting at least one distance adjuster to the panel support member;
moving the at least one distance adjuster to reduce the spaces of the panel support member;
stacking a lower protection member on a surface of the panel support member; and
removing the at least one distance adjuster from the panel support member.

11. The method of claim 10,
wherein the panel support member comprises:
a first non-folding portion; and
a second non-folding portion spaced apart from the first non-folding portion,
wherein the folding portion is located between the first non-folding portion and the second non-folding portion, and
wherein the connecting of the at least one distance adjuster to the panel support member comprises:
connecting the at least one distance adjuster to the first non-folding portion, the second non-folding portion, and each of the multiple bars.

12. The method of claim 11,
wherein the at least one distance adjuster comprises a moving member, connecting wires, and bridges, and
wherein the connecting of the at least one distance adjuster to the panel support member comprises:
connecting first ends of the connecting wires to the first non-folding portion, the second non-folding portion and the multiple bars;
connecting second ends, opposite to the first ends, of the connecting wires to the moving member; and
connecting the first non-folding portion and the second non-folding portion with the moving member through the bridges.

13. The method of claim 12, further comprising:
placing the panel support member with the at least one distance adjuster connected thereto on a stacking jig; and
removing, after the placing of the panel support member on the stacking jig, the bridges from the panel support member.

14. An electronic device comprising:
a display device; and
a power supply configured to provide power to the display device,
wherein the display device comprises:
a display panel comprising a folding area; and
a panel support member disposed on a surface of the display panel, and
wherein the panel support member comprises:
a folding portion overlapping the folding area; and
multiple bars spaced apart from each other in the folding portion.

15. The electronic device of claim 14,
wherein each bar of the multiple bars extends lengthwise in a first direction and the multiple bars are spaced apart from each other in a second direction perpendicular to the first direction, and
wherein the panel support member extends lengthwise in the second direction.

16. The electronic device of claim 15,
wherein the panel support member has longer sides extending in the second direction, and shorter sides extending in the first direction,
wherein a length of the multiple bars in the first direction is equal to a length of the shorter sides of the panel support member,
wherein each bar of the multiple bars extends lengthwise in the first direction and the multiple bars are spaced apart from each other in the second direction perpendicular to the first direction, and
wherein the panel support member extends lengthwise in the second direction.

17. The electronic device of claim 15,
wherein the panel support member further comprises:
a first non-folding portion; and
a second non-folding portion spaced apart from the first non-folding portion,
wherein the folding portion is located between the first non-folding portion and the second non-folding portion, and
wherein a first space is formed between the first non-folding portion and a first outermost bar of the multiple bars, multiple second spaces are formed between two adjacent multiple bars of the multiple bars, and a third space is formed between the second non-folding portion and a second outermost bar of the multiple bars.

18. The electronic device of claim 17,
wherein a width of the first space in the second direction is less than a half of a thickness of the first outermost bar in a third direction perpendicular to the first and second directions.

19. The electronic device of claim 18, further comprising:
a lower protection member disposed between the display panel and the panel support member,
wherein the lower protection member is attached to the panel support member and is configured to maintain the first space, the multiple second spaces, and the third space.

20. The electronic device of claim 19,
wherein the lower protection member has a recessed surface at a lower surface,
wherein the lower surface except for the recessed surface contacts the panel support member, and
wherein the recessed surface is spaced apart from a region where the multiple bars arc disposed.
